(19) United States
(12) Patent Application Publication
(10) Pub. No.: US 2026/0058456 A1
(43) Pub. Date: Feb. 26, 2026

(54) STUB UP ASSEMBLY AND SYSTEM AND METHOD FOR BRINGING UNDERGROUND DUCT BANK CONDUITS TO A SITE SURFACE

(71) Applicant: CONTECH ENGINEERED SOLUTIONS LLC, West Chester, OH (US)

(72) Inventors: Matthew James KRANITZ, St. Paul, MN (US); Nicholas A. KRUG, Old Hickory, TN (US); Matthew Carl PEARSON, Maple Grove, MN (US)

(21) Appl. No.: 18/815,224

(22) Filed: Aug. 26, 2024

(51) Int. Cl. H02G 9/06; H02G 3/04

(52) U.S. Cl. CPC H02G 9/06; H02G 3/0493

(57) ABSTRACT

A preformed stub-up assembly module is provided for use in redirecting underground conduit upward to a site surface of an installation site. The assembly module includes at least one first elongate conduit for receiving and passing through a service delivery media, the first elongate conduit being curved along a majority of its length and having a first mating end and a second mating end; and an encasing body formed before module placement and encasing at least part of the first elongate conduit, the encasing body having a bottom surface that defines a base plane. The first mating end extends from the encasing body in a first direction that is substantially parallel to the base plane, and the second mating end extends from the encasing body in a second direction that is angled upwardly from the base plane and away from the first mating end.

### TECHNICAL FIELD

This application relates generally to systems for passing through of wires, communication lines, information lines, power lines, electrical lines, fluids, or any elongated or flowing materials or devices suitable for such passage and, more particularly, to an assembly, system and method for bringing underground duct bank conduits upward to a site surface location.

### BACKGROUND

When running electrical or communication lines underground, the lines are often passed through conduits or pipes to help protect the lines from electrical short, fire, explosion, or deterioration or damage due to moisture, rodents, human activity such as digging, shifts in surrounding dirt, gravel or other granular fill and other adverse conditions or activities. In some cases, the pipes may be arranged in an excavation and may further be encased in precast concrete duct assemblies, as described in U.S. Patent Nos. 10,876,661 and 8,689,502. In the past, one technique used to bring the electrical or communication lines to a site surface (e.g., within or adjacent to a building) is a cast-in-place system has been used to create a ninety degree upward turn of conduit at the desired location. This cast-in-place process creates difficulties for formwork and for achieving the desired final location. Another technique used has been precast 90-degree turn modules, such as the module 5 shown in FIG. 1. However, precast units of this type tend to be excessively large, creating difficulties for handling and transport to the installation site.

Accordingly, it would be desirable to provide an improved assembly and system and method for bringing duct assembly conduit to a site surface.

### SUMMARY

In one aspect, a preformed stub-up assembly module is provided for use in redirecting underground conduit upward to a site surface of an installation site. The assembly module includes at least one first elongate conduit for receiving and passing through a service delivery media, the first elongate conduit being curved along a majority of its length and having a first mating end and a second mating end; and an encasing body formed before module placement and encasing at least part of the first elongate conduit, the encasing body having a bottom surface that defines a base plane. The first mating end extends from the encasing body in a first direction that is substantially parallel to the base plane, and the second mating end extends from the encasing body in a second direction that is angled upwardly from the base plane and away from the first mating end.

In another aspect, a preformed stub-up assembly module for use in redirecting underground conduit upward to a site surface of an installation site includes a plurality of first elongate conduit sections, each first elongate conduit section being curved along a majority of its length and having a first mating end and a second mating end. An encasing body is formed before module placement and encases at least part of each of the first elongate conduit sections. The first mating ends extend from the encasing body in a first direction and the second mating ends extend from the encasing body in a second direction that is angled upwardly and away from the first direction.

In another aspect, a method of redirecting an underground conduit path upward to a site surface of an installation site involves: receiving a preformed stub-up assembly module at an install site, wherein the preformed stub-up assembly includes a first elongate conduit section that is curved along a majority of its length and having a first mating end and a second mating end, and an encasing body encasing the majority of the first elongate conduit section, wherein the first mating end extends from the encasing body in a first direction and the second mating end extends from the encasing body in a second direction that is angled upwardly and away from the first mating end; and after the receiving, connecting a lower end of a second elongate conduit section to the second mating end, the second elongate conduit section being curved along a majority of its length having an upper end that extends in a substantially vertical direction.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 shows a prior art module;

FIG. 2 shows a perspective view of a pre-formed stub-up assembly module;

FIG. 3 shows a side elevation of the assembly module;

FIG. 4 shows the module with further conduit sections connected;

FIGS. 5 and 6 show side and elevations of the module with the further conduit sections connected;

FIG. 7 shows the module with further conduits sections attached and formwork added;

FIGS. 8 and 9 show side and end elevations with a cast-in-place encasement shown in dashed line form;

FIG. 10 shows a formwork system for forming a stub-up assembly module;

FIG. 11 shows another side elevation;

FIG. 12 shows another side elevation with module placed in a trench; and

FIG. 13 shows alternative profile configurations for a stub-up assembly module.

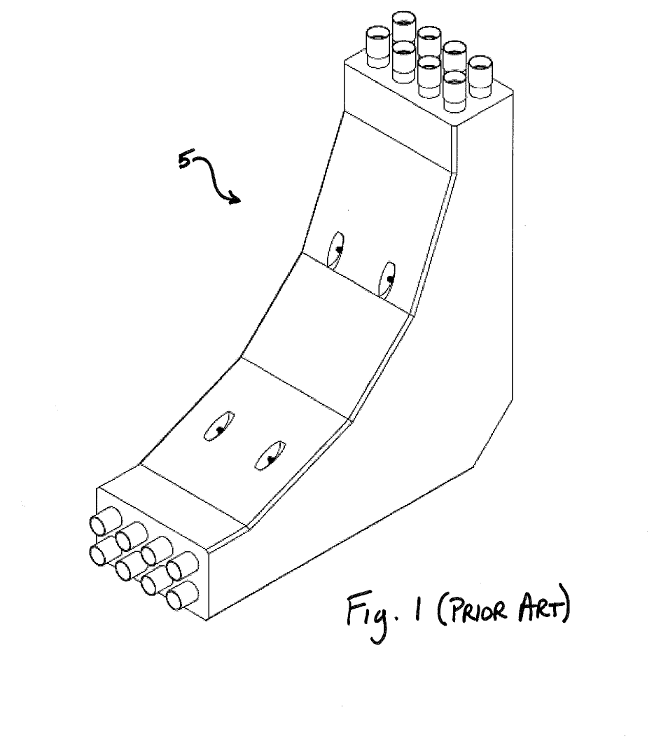

### DETAILED DESCRIPTION

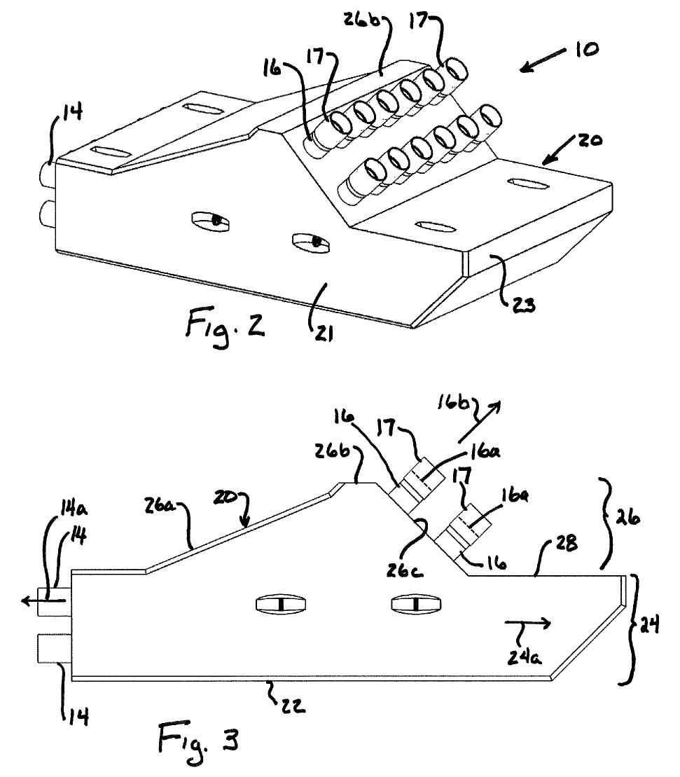

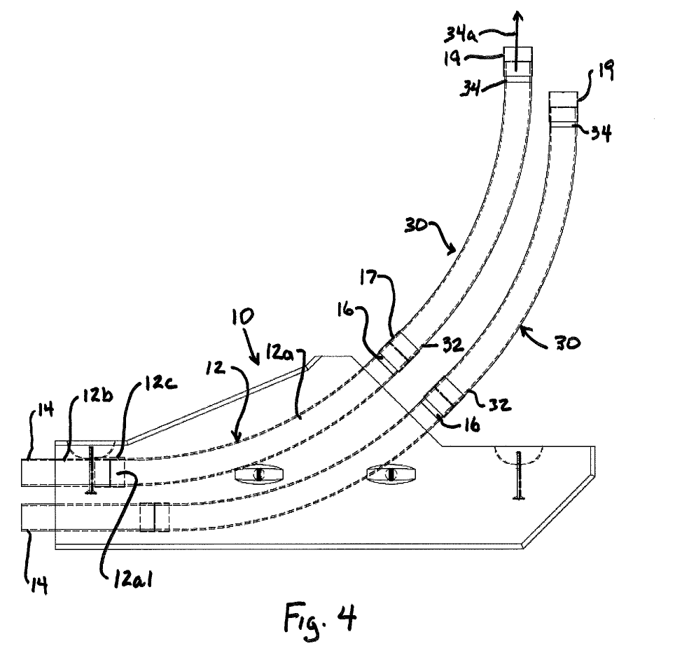

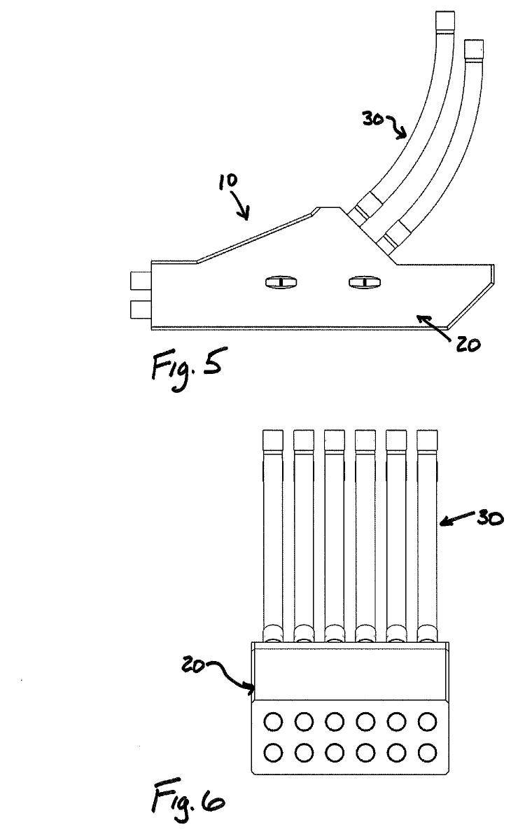

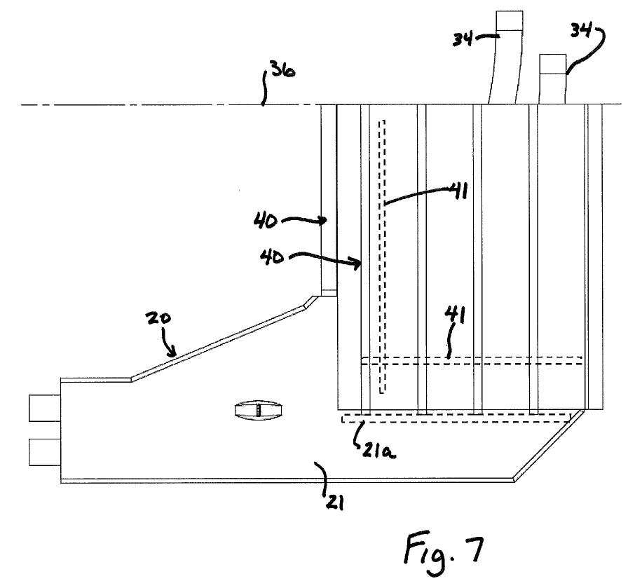

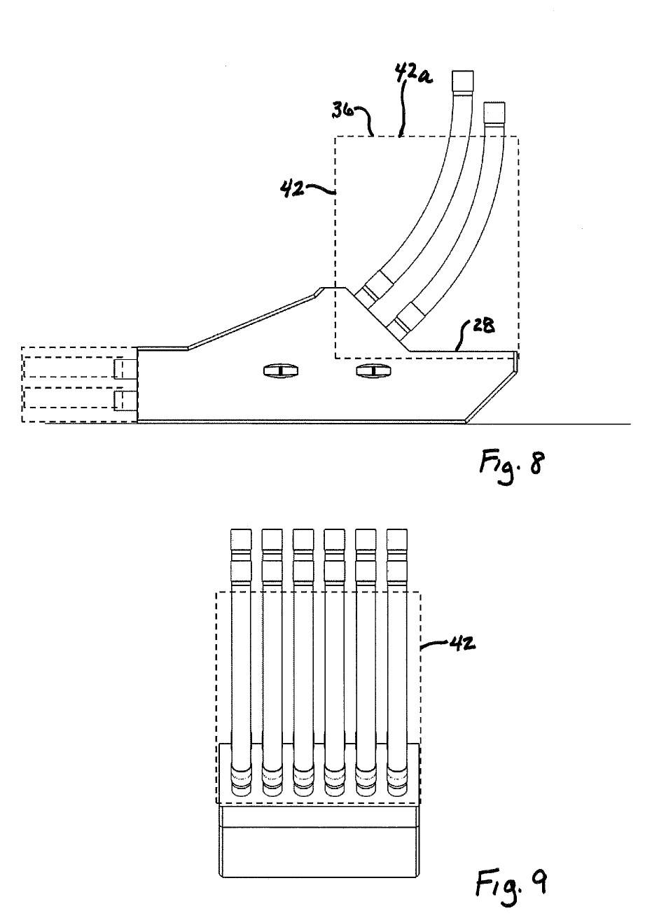

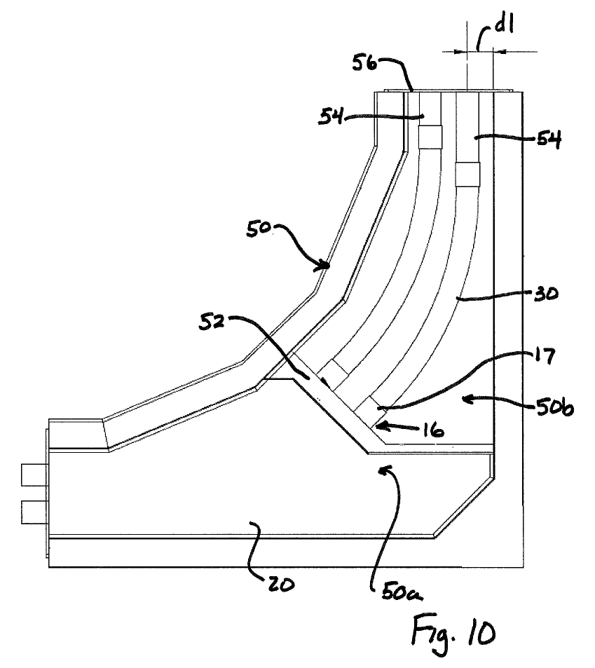

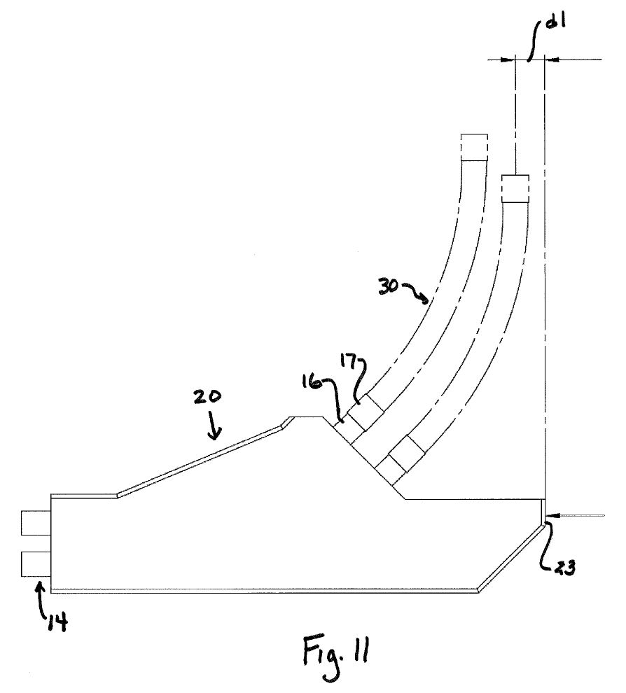

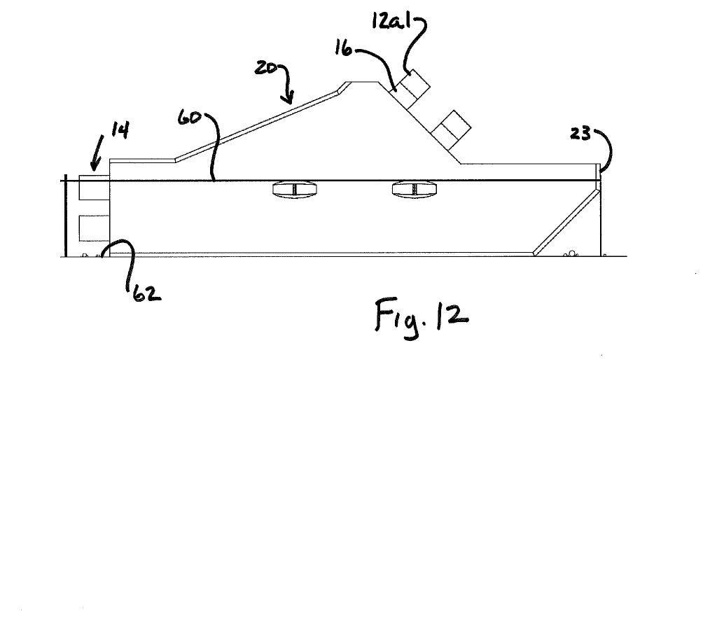

Referring to FIGS. 2-12, a preformed stub-up assembly module 10 is shown, which is adapted for use in redirecting underground conduit upward to a site surface of an installation site (e.g., to the bottom of a foundation elevation). The module 10 includes one or more elongate conduit sections 12 for receiving and passing through a service delivery media (e.g., power cable, communications cable etc.). The conduit sections 12 are curved along a majority of their lengths, and have opposite mating ends 14 and 16. Here, the conduit sections 12 are formed by curved conduits 12a mated with straight conduits 12b by couplers 12c. The curved conduits 12a may include short straight segments 12a1 at both ends that facilitate coupling into conduit couplers. The end edges 16a of the mating ends 16 may be disposed within couplers 17. An encasing body 20 is formed before module delivery to the site for placement and may typically be of precast concrete, though other materials (e.g., polymer concrete, fiber reinforced concrete) may be used. The encasing body encases at least part of each of the elongate conduit section 12. The encasing body 20 has a bottom surface 22 that defines a base plane that will sit in the bottom of a site install location, such as the bottom of a site trench. Here, the mating ends 14 extend from the encasing body 20 in a direction 14a that is substantially parallel to the base plane or bottom surface 22, and the mating ends 16 extend from the encasing body in a direction 16b that is angled upwardly from the bottom surface 22 or base plane and upwardly and away from the mating end 14, such that direction 16b includes a component that is opposite to direction 14a (e.g., in FIG. 3 direction 14a is horizontal to the left and direction 16b includes a component that is horizontal to the right). Directions 14a and 16b are defined by the center axes of the of the end segments. In embodiments, the direction 16b is angularly oriented relative to the base plane at an angle of between thirty degrees and sixty degrees, such as between forty degrees and fifty degrees, such as substantially forty-five degrees.

Here, the encasing body 20 includes a lower portion 24 and an upper portion 26. The mating ends 14 extend from the lower portion 24, and the mating ends 16 extend from the upper portion 26. Here, the upper portion 26 is defined by an angularly upward ramp surface 26a, a top surface 26b and an angularly downward ramp surface 26c. The mating ends 16 extend outward from the surface 26c. Here, surface 26c extends at about a forty-five degree angle relative to vertical, while the surface 26a extends at an angle that is less steep than that of surface 26c.

Notably, the lower portion 24 of the encasing beyond extends laterally beyond the mating ends 16 in a third direction 24a that is opposite the direction 14a. This extending part of the lower portion 24 forms an upwardly facing support shelf 28. Here, the support shelf 28 runs substantially parallel to the bottom surface 22.

In practice, after the assembly module 10 is formed, it is shipped to the site with further conduit sections 30 that are configured to be joined to the mating ends 16 of the conduits 12 via couplers 17. The lower ends 32 of the further conduit sections 30 are joined to the mating ends 16 by the couplers. The further conduit sections 30 are curved along a majority of their lengths, and the upper ends 34 thereby extend upward in a direction 34a, which here is substantially perpendicular to the direction 14a. By providing the further conduit sections 30 as separate components to be connected on-site, shipment of the assembly module 10 is facilitated. Typically, the assembly module 10 will be shipped with the further conduit sections 30 as separate parts (e.g., the assembly module 10 and the conduit sections 30, with couplers 17 and 19, operate like a kit).

After the further conduit sections 30 are connected, formwork 40 can be added around the mating ends 16 and the further conduits 30, along with any reinforcement 41 needed. The encasing body 20 is configured to facilitate the addition of the formwork 40, such as by having parallel lateral and planar side surfaces 21, planar end surface 23 and planar top surface 26b along or atop which the formwork can lie. In other embodiments, additional structure could be provided for supporting the formwork, such as ledges 21a on side surfaces 21. Once the formwork is completed, an on-site addition of cast-in-place encasing material (e.g., cast-in-place concrete) is added to the form to result in a cast-in-place encasing body 42 that is at least partly supported atop the shelf 28 and that encases the mating ends 16, the lower ends 32 and a majority of the further elongate conduit sections 30, up to a location 36 that is below the upper ends 34. Location 36 may, for example, be set to a bottom elevation of a foundation that will be formed later.

In embodiments, the conduit sections 30 and the formwork 40 are added on-site prior to placement of the assembly module 10 in the site trench. Once the conduit sections 30 and formwork 40, which may be remain in place formwork, and any reinforcement are in place, the assembly module 10 with connected conduit sections 30 and attached formwork may be placed in the site trench as the necessary location, and then the concrete poured. In other embodiments, the conduit sections 30 and/or the formwork could be added after the assembly module 10 has been placed into final position in the site trench.

The stub-up assembly module and system described above provides an advantageous system and method for bringing undergound duct bank conduits up to a site surface. In particular, a method of redirecting an underground conduit path upward to a site surface of an installation site, involves: receiving at an installation site a preformed stub-up assembly module 10 that includes one or more elongate conduit sections 12 that are curved along a majority of their lengths and have mating ends 14 and 16, and an encasing body 20 encasing the majority of the elongate conduit sections 12, wherein the mating ends 14 extend from the encasing body 20 in directions 14a and the mating ends 16 extend from the encasing body 20 in directions 16a that are angled upwardly and away from the mating ends 14. The delivery to the site may be accompanied by further elongated conduit sections 30, having lower ends 32 that are connected to the mating ends 16 on site, where the elongate conduit sections 30 are also curved along a majority of their lengths and have upper ends 34 that extend in a substantially vertical direction. Thereafter, and typically after placement into a site trench and addition of needed formwork 40, the mating ends 16, the lower ends 32 and a majority of the elongate conduit sections 30 are encased in a cast-in-place encasing body 42 that extends up to a location 36 that is below the upper ends 34. To facilitate this method, the preformed stub-up assembly module 10 defines a shelf 28 below the elongate conduit sections 30 and on which the cast-in-place encasing body 42 is at least partly supported.

In practice, the stub-up assembly module 10 may be precast (off-site) while the further conduit sections 30 are connected to the conduits 12. This assures that that a precise and required location of the mating ends 14 and the upper ends 34 is achieved prior to forming the encasing body 20 (e.g., prior to pouring the concrete into the formwork). To achieve this a formwork system 50 may be used that is suited for formation of a complete right- angle encasement, but where a blockout 52 is used in the formwork to define a pour side 50a and a no pour side 50b such that the mating ends 16 and the further conduit sections 30 do not become encased in the encasing body 20. The conduit sections 30 can thereafter be removed for shipping with the module 10. In embodiments, prior to the pour, the upper ends of the conduit sections 30 may be connected to straight conduits 54 that are engaged in openings of an end plate 56 to help define the desired orientation and position of the ends 16 of the conduit sections 12 before the encasing body 20 is formed.

This process for producing the stub-up assembly module 10 helps define a relatively precise and known location between where the end surface 23 is located and where the upper ends 34 of the conduit sections 30 will be upon final assembly on-site (e.g., the spacing d1 is precisely defined). During site install, this allows the end surface 23 to be used to define the final location of the module 10 (e.g., by using a string line 60 when the module is resting at the trench bottom 62). The conduit sections 30 and formwork 40 (field connected before or after placement of the module 10 into the site trench) and on-site pour of the encasing body 42 will result in desired positioning of the upper ends of the conduit sections 30 at locations above an elevation plane 64 that defines the bottom location of the to be formed foundation. Notably, the upper surface 42a of field produced encasing body 42 can be at the same level as the elevation plane 36, such that the bottom of the foundation, once formed, will lie atop the surface 42a.

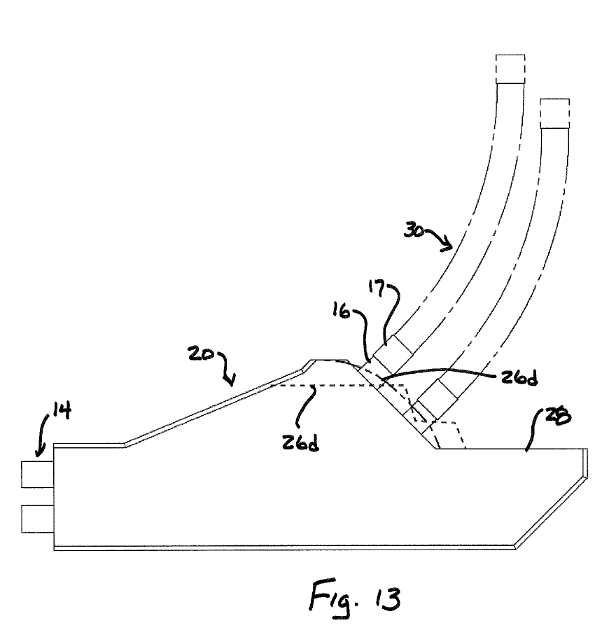

It is to be clearly understood that the above description is intended by way of illustration and example only, is not intended to be taken by way of limitation, and that other changes and modifications are possible. For example, FIG. 13 shows alternative profile shapes for the encasing body 20, including a stepped profile section 26d and a curved profile section 26e.

The scope of protection of each following claim shall only be limited by features expressly set forth in such claim.

CLAIMS

1. A preformed stub-up assembly module for use in redirecting underground conduit upward to a site surface of an installation site, the assembly module comprising:
at least one first elongate conduit section for receiving and passing through a service delivery media, the first elongate conduit section being curved along a majority of its length and having a first mating end and a second mating end; and
an encasing body formed before module placement and encasing at least part of the first elongate conduit section, the encasing body having a bottom surface that defines a base plane;
wherein the first mating end extends from the encasing body in a first direction that is substantially parallel to the base plane, and the second mating end extends from the encasing body in a second direction that is angled upwardly from the base plane and away from the first mating end.

2. The assembly module of claim 1, wherein the second direction is angularly oriented relative to the base plane at an angle of between forty degrees and fifty degrees.

3. The assembly module of claim 1, wherein the encasing body includes a lower portion and an upper portion, wherein the first mating end extends from the lower portion, wherein the second mating end extends from the upper portion.

4. The assembly module of claim 3, wherein the lower portion of the encasing body extends laterally beyond the second mating end in a third direction that is opposite the first direction.

5. A system, comprising:
the assembly module of claim 3; and
a second elongate conduit section having a lower end connected to the first mating end of the first elongate conduit section, the second elongate conduit section being curved along a majority of its length, the second elongate conduit section having an upper end that extends upward in a fourth direction that is substantially perpendicular to the first direction.

6. The system of claim 5, wherein the lower portion has an upper surface that forms a shelf below the second elongate conduit.

7. The system of 5, further comprising a cast-in-place encasing body at least partly supported atop the shelf and encasing the second mating end of the first elongate conduit section, the lower end of the second elongate conduit section and a majority of the second elongate conduit section to a location below the upper end.

8. The system of claim 5, wherein the shelf runs substantially parallel to the base plane.

9. The system of claim 5, wherein a location and orientation of the second elongate conduit section are defined by one or more edges of the shelf such that an install position of the second elongate conduit section is predefined prior to mating of the second elongate conduit section to the first elongate conduit section.

10. A preformed stub-up assembly module for use in redirecting underground conduit upward to a site surface of an installation site, the assembly module comprising:
a plurality of first elongate conduit sections, each first elongate conduit section being curved along a majority of its length and having a first mating end and a second mating end; and
an encasing body formed before module placement and encasing at least part of each of the first elongate conduit sections;
wherein the first mating ends extend from the encasing body in a first direction and the second mating ends extend from the encasing body in a second direction that is angled upwardly and away from the first direction.

11. The assembly module of claim 10, wherein the encasing body includes a lower portion and an upper portion, wherein the first mating ends extend from the lower portion, wherein the second mating ends extend from the upper portion.

12. The assembly module of claim 11, wherein the lower portion of the encasing body extends laterally beyond the second mating ends to form a shelf below the second mating ends.

13. A method of redirecting an underground conduit path upward to a site surface of an installation site, the method comprising:
receiving a preformed stub-up assembly module at an install site, wherein the preformed stub-up assembly includes a first elongate conduit section that is curved along a majority of its length and having a first mating end and a second mating end, and an encasing body encasing the majority of the first elongate conduit section, wherein the first mating end extends from the encasing body in a first direction and the second mating end extends from the encasing body in a second direction that is angled upwardly and away from the first mating end;
after the receiving, connecting a lower end of a second elongate conduit section to the second mating end, the second elongate conduit section being curved along a majority of its length having an upper end that extends in a substantially vertical direction.

14. The method of claim 13, further comprising:
encasing the second mating end of the first elongate conduit section, the lower end of the second elongate conduit section and a majority of the second elongate conduit section in a cast-in-place encasing body that extends to a location below the upper end of the second elongate conduit section.

15. The method of claim 14, wherein the preformed stub-up assembly module defines a shelf below the second elongate conduit section and on which the cast-in-place encasing body is at least partly supported.
